(19) United States
(12) Patent Application Publication
(10) Pub. No.: US 2026/0077976 A1
(43) Pub. Date: Mar. 19, 2026

(54) POST-PROCESSING DEVICE AND IMAGE FORMING APPARATUS

(71) Applicant: FUJIFILM Business Innovation Corp., Tokyo (JP)

(72) Inventors: Jun SHIBUYA, Kanagawa (JP); Takayuki UCHIYAMA, Kanagawa (JP); Kazuyuki KODA, Kanagawa (JP); Akira ITO, Kanagawa (JP); Hideki KAYASHIMA, Kanagawa (JP); Takumi UEGANE, Kanagawa (JP); Takuya MAKITA, Kanagawa (JP); Masatoshi SUZUKI, Kanagawa (JP); Taku KIYOMASA, Kanagawa (JP); Shota SAITO, Kanagawa (JP)

(73) Assignee: FUJIFILM Business Innovation Corp., Tokyo (JP)

(21) Appl. No.: 19/063,883

(22) Filed: Feb. 26, 2025

(30) Foreign Application Priority Data
Sep. 17, 2024 (JP) 2024-160120

(51) Int. Cl. B65H 37/04; G03G 15/00

(52) U.S. Cl. CPC B65H 37/04; G03G 15/6544; B65H 2301/51611; B65H 2301/51616; B65H 2408/1222; B65H 2513/512; B65H 2557/30; B65H 2801/27; G03G 2215/00827

(57) ABSTRACT

A post-processing device includes a staple fastening device that fastens a medium with a staple; a stapleless fastening device that fastens a medium without using the staple; and a guiding part that guides the staple fastening device and the stapleless fastening device such that the staple fastening device and the stapleless fastening device are movable in a width direction of a medium, in which a moving speed of the stapleless fastening device is slower than a moving speed of the staple fastening device when a moving timing of the staple fastening device and a moving timing of the stapleless fastening device overlap each other.

### CROSS-REFERENCE TO RELATED APPLICATIONS

This application is based on and claims priority under 35 USC 119 from Japanese Patent Application No. 2024-160120 filed Sep. 17, 2024.

### BACKGROUND

### (i) Technical Field

The present disclosure relates to a post-processing device and an image forming apparatus including the post-processing device.

### (ii) Related Art

Regarding a fastening device, commonly known as a stapler device, that fastens a bundle of media on which images are recorded by an image recording device, the technology described in Japanese Unexamined Patent Application Publication No. 2022-125834 (FIG. 2, FIG. 4 to FIG. 7, and FIG. 13) and the technology described in Japanese Unexamined Patent Application Publication No. 2017-105569 ([0060] to [0070] and FIG. 3) are publicly known in the related art.

Japanese Unexamined Patent Application Publication No. 2022-125834 describes a configuration in which a staple fastening device (500) and a stapleless fastening device (600) move on an identical guide rail (450). In Japanese Unexamined Patent Application Publication No. 2022-125834, the staple fastening device (500) and the stapleless fastening device (600) are configured to retract to positions away from each other at an identical end portion.

Japanese Unexamined Patent Application Publication No. 2017-105569 describes a configuration in which a staple fastening unit (30) and a stapleless fastening unit (40) are disposed away from each other at two end portions of an apparatus. The staple fastening unit (30) in Japanese Unexamined Patent Application Publication No. 2017-105569 is capable of performing end-fastening in which multiple portions of an edge of each sheet are fastened. Meanwhile, the stapleless fastening unit (40) is capable of performing corner-fastening in which corners of sheets are diagonally fastened.

### SUMMARY

Aspects of non-limiting embodiments of the present disclosure relate to a post-processing device in which timings of movements of a stapleless fastening device and a staple fastening device along a guiding part overlap each other to achieve a technical feature that vibration of the post-processing device is suppressed compared with when the stapleless fastening device and the staple fastening device move at the same speeds.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, to achieve the above technical feature, there is provided a post-processing device including:
a staple fastening device that fastens a medium with a staple;
a stapleless fastening device that fastens a medium without using the staple; and
a guiding part that guides the staple fastening device and the stapleless fastening device such that the staple fastening device and the stapleless fastening device are movable in a width direction of a medium,
in which a moving speed of the stapleless fastening device is slower than a moving speed of the staple fastening device when a moving timing of the staple fastening device and a moving timing of the stapleless fastening device overlap each other.

### BRIEF DESCRIPTION OF THE DRAWINGS

An exemplary embodiment of the present disclosure will be described in detail based on the following figures, wherein:

FIG. 1 is an explanatory view of the entirety of an image forming apparatus in Example 1;

FIG. 2 is an explanatory view of portions of an image recording unit in Example 1;

FIG. 3 is a plan view of a post-processing device in Example 1;

FIGS. 4A and 4B are explanatory views of portions of a guiding part and a switching part in Example 1, FIG. 4A being a plan view of a rear portion, FIG. 4B being a perspective view in the direction indicated by the arrow IVB;

FIGS. 5A, 5B, and 5C are explanatory views of the switching part in Example 1, FIG. 5A being a perspective view of the switching part, FIG. 5B being an explanatory view of a state in which the switching part has moved to a second guide position, FIG. 5C being an explanatory view of a state in which the switching part has moved to a third guide position;

FIGS. 6A and 6B are explanatory views of the guiding part and the switching part in Example 1, FIG. 6A being an explanatory view of a state in which the switching part has moved to the second guide position, FIG. 6B being an explanatory view of a state in which the switching part has moved to the third guide position;

FIGS. 7A and 7B are explanatory views of a stapling unit in Example 1, FIG. 7A being an explanatory view of a stapleless stapling unit, FIG. 7B being an explanatory view of a staple stapling unit;

FIGS. 8A, 8B, 8C, and 8D are explanatory views of the stapleless stapling unit in Example 1, FIG. 8A being an explanatory view of a state in which the stapleless stapling unit has moved to an end fastening position, FIG. 8B being an explanatory view of a state in which the stapleless stapling unit has moved to a rear corner fastening position, FIG. 8C being an explanatory view of a state in which the stapleless stapling unit has moved to a retraction position, FIG. 8D being an explanatory view of a state while the stapleless stapling unit moves forward from the retraction position;

FIG. 9 is an explanatory view of the movement of the staple stapling unit in Example 1;

FIG. 10 is a functional block diagram of a controller in Example 1;

FIGS. 11A and 11B are explanatory views of positions of a fastening device in Example 1, FIG. 11A being an explanatory view of a position for a non-operation time, FIG. 11B being an explanatory view of a position for performing alignment processing;

FIGS. 12A and 12B are explanatory views of positions at which the fastening device in Example 1 performs staple corner fastening, FIG. 12A being an explanatory view of a position for a paper loading time, FIG. 12B being an explanatory view of a state in which the fastening device has moved to a staple corner-fastening position;

FIGS. 13A, 13B, and 13C are explanatory views of positions at which the fastening device in Example 1 performs staple end fastening, FIG. 13A being an explanatory view of a position for a paper loading time, FIG. 13B being an explanatory view of a state of first stapling of the staple end fastening, FIG. 13C being an explanatory view of a state of second stapling of the staple end fastening;

FIGS. 14A, 14B, and 14C are explanatory views of positions at which the fastening device in Example 1 performs stapleless corner fastening, FIG. 14A being an explanatory view of a state in which the fastening device has passed through the switching part before paper loading, FIG. 14B being an explanatory view of a position for a paper loading time, FIG. 14C being an explanatory view of a state in which the fastening device has moved to a stapleless corner-end fastening position; and

FIGS. 15A, 15B, and 15C are explanatory views of positions at which the fastening device in Example 1 performs stapleless end fastening, FIG. 15A being an explanatory view of a position for a paper loading time, FIG. 15B being an explanatory view of a state of first stapling of the stapleless end fastening, FIG. 15C being an explanatory view of a state of second stapling of the stapleless end fastening.

### DETAILED DESCRIPTION

Next, an example as a specific example of the exemplary embodiment of the present disclosure will be described with reference to the drawings. The present disclosure is, however, not limited to the following example.

Note that, for ease of understanding of the following description, it is defined that, in the drawings, the front-rear direction is the X-axis direction, the left-right direction is the Y-axis direction, the up-down direction is the Z-axis direction, and the directions or the sides indicated by the arrows X, −X, Y, −Y, Z, and −Z are forward, rearward, rightward, leftward, upward, and downward or the front side, the rear side, the right side, the left side, the upper side, and the lower side, respectively.

In the drawings, the arrows with a dot in a circle are arrows in a direction from the back toward the front of the sheet surfaces of the drawings while the arrows with a cross in a circle are arrows in a direction from the front toward the back of the sheet surfaces of the drawings.

In the following description using the drawings, illustration of members other than members needed in the description are omitted, as appropriate, for ease of understanding.

### Example 1

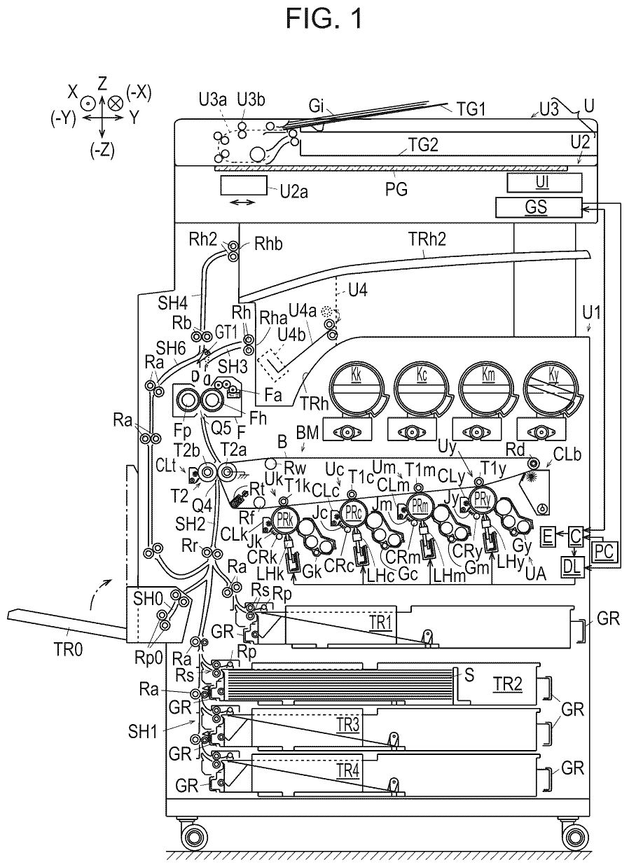

FIG. 1 is an explanatory view of the entirety of the image forming apparatus in Example 1.

In FIG. 1, a copier U as one example of the image forming apparatus in Example 1 of the present disclosure includes a printer unit U1 as one example of an image recording part and as one example of an image recording device. A scanner unit U2 as one example of a reading unit and as one example of an image reading device is supported at an upper portion of the printer unit U1. An automatic feeder U3 as one example of a document transport device is supported at an upper portion of the scanner unit U2.

A document tray TG1 as one example of a medium accommodation part is disposed at an upper portion of the automatic feeder U3. The document tray TG1 is able to accommodate multiple to-be-copied documents Gi in a stacked state. A document paper output tray TG2 as one example of a document output portion is formed below the document tray TG1. Between the document tray TG1 and the document paper output tray TG2, document transport rollers U3b are disposed along a document transport path U3a.

A platen glass PG as one example of a transparent document holder is disposed on the upper surface of the scanner unit U2. In the scanner unit U2 in Example 1, a reading unit U2a as one example of a reading portion is disposed below the platen glass PG. The reading unit U2a in Example 1 is supported to be movable along the lower surface of the platen glass PG in the left-right direction as one example of a sub-scanning direction. The reading unit U2a is electrically connected to an image processing unit GS.

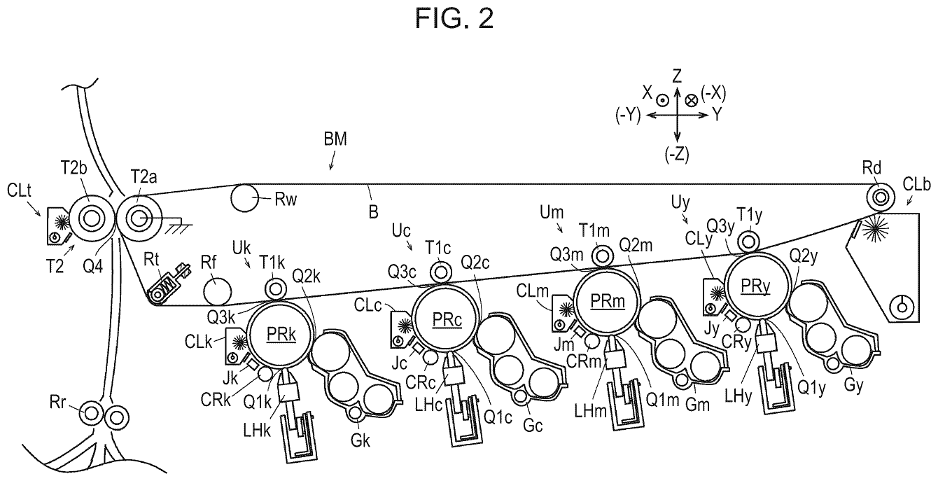

FIG. 2 is an explanatory view of portions of the image recording unit in Example 1. The image processing unit GS is electrically connected to a writing circuit DL of the printer unit U1. The writing circuit DL is electrically connected to exposure devices LHy, LHm, LHc, and LHk as one example of a latent-image forming part.

As one example, the exposure devices LHy to LHk in Example 1 are each constituted by an LED head in which multiple LEDs are arranged side by side in a main scanning direction. The exposure devices LHy to LHk are each configured to be able to output writing light corresponding to respective colors of yellow (Y), magenta (M), cyan (C), and black (K) in accordance with a signal received from the writing circuit DL.

The writing timing of the writing circuit DL and the power supply timing of a power supply circuit E are controlled in accordance with control signals from a controller C as one example of a control part.

In FIG. 1, photoreceptors PRy, PRm, PRc, and PRk as one example of an image carrying part are disposed above the exposure devices LHy to LHk. In FIG. 1 and FIG. 2, regions where the photoreceptors PRy to PRk are irradiated with writing light constitute writing regions Q1y, Q1m, Q1c, and Q1k.

Charging rollers CRy, CRm, CRc, and CRk as one example of a charging part are disposed upstream of the writing regions Q1y to Q1k, respectively, in a rotation direction of each of the photoreceptors PRy to PRk. The charging rollers CRy to CRk in Example 1 are supported to be able to rotate by being in contact with and driven by the photoreceptors PRy to PRk, respectively.

Developing devices Gy, Gm, Gc, and Gk as one example of a developing part are disposed downstream of the writing regions Q1y to Q1k, respectively, in the rotation direction of each of the photoreceptors PRy to PRk. Regions where the photoreceptors PRy to PRk face the developing devices Gy to Gk corresponding thereto constitute development regions Q2y, Q2m, Q2c, and Q2k.

First transfer rollers T1y, T1m, T1c, and T1k as one example of a first transfer part are disposed downstream of the developing devices Gy to Gk, respectively, in the rotation direction of each of the photoreceptors PRy to PRk. Regions where the photoreceptors PRy to PRk face the first transfer rollers T1y to T1k corresponding thereto constitute first transfer regions Q3y, Q3m, Q3c, and Q3k.

Photoreceptor cleaners CLy, CLm, CLc, and CLk as one example of a cleaning part are disposed downstream of the first transfer rollers T1y to T1k, respectively, in the rotation direction of each of the photoreceptors PRy to PRk.

Static eliminators Jy, Jm, Jc, and Jk as one example of a static elimination part and as one example of a static elimination device are disposed downstream of the photoreceptor cleaners CLy to CLk, respectively, in the rotation direction of each of the photoreceptors PRy to PRk.

The photoreceptor PRy, the charging roller CRy, the exposure device LHy, the developing device Gy, the first transfer roller T1y, the photoreceptor cleaner CLy, and the static eliminator Jy, which are for the Y-color, constitute a Y-color image formation unit Uy, as one example of a Y-color visible-image formation part in Example 1, that forms a Y-color toner image. Similarly, each of the photoreceptors PRm, PRc, and PRk, each of the charging rollers CRm, CRc, and CRk, each of the exposure devices LHm, LHc, and LHk, each of the developing devices Gm, Gc, and Gk, each of the first transfer rollers T1m, T1c, and T1k, each of the photoreceptor cleaners CLm, CLc, and CLk, and each of the static eliminators Jm, Jc, and Jk constitute a corresponding one of an image formation unit Um for the M-color, the image formation unit Uc for the C-color, and the image formation unit Uk for the K-color.

A belt module BM as one example of an intermediate transfer device is disposed above the photoreceptors PRy to PRk. The belt module BM includes an intermediate transfer belt B as one example of an image carrying part and as one example of an intermediate transfer part. The intermediate transfer belt B is constituted by an endless belt-shaped member.

The intermediate transfer belt B in Example 1 is rotatably supported by a tension roller Rt as one example of a stretching part, a walking roller Rw as one example of a skew correction part, an idler roller Rf as one example of a driven part, a backup roller T2a as one example of a part that faces a second transfer region, the first transfer rollers T1y to T1k, and a drive roller Rd as one example of a drive member. In Example 1, the intermediate transfer belt B rotates when drive is transmitted to the drive roller Rd.

A second transfer roller T2b as one example of a second transfer part is disposed at a position to face the backup roller T2a with the intermediate transfer belt B interposed therebetween. The backup roller T2a, the second transfer roller T2b, and the like constitute a second transfer unit T2, as one example of a transfer device, in Example 1. A region where the second transfer roller T2b faces the intermediate transfer belt B constitutes a second transfer region Q4.

A belt cleaner CLb as one example of a cleaning device for an intermediate transfer body is disposed downstream of the secondary transfer region Q4 in a rotation direction of the intermediate transfer belt B.

The first transfer rollers T1y to T1k, the intermediate transfer belt B, the second transfer unit T2, and the like constitute a transfer device T1+T2+B as one example of a transfer part in Example 1. In addition, the image formation units Uy to Uk and the transfer device T1+T2+B constitute an image recording unit Uy to Uk+T1+T2+B in Example 1.

In FIG. 1, a left-right pair of guide rails GR as one example of a guiding part is provided on each of four tiers below the image formation units Uy to Uk. Each pair of the guide rails GR supports a corresponding one of paper-feeding trays TR1, TR2, TR3, and TR4 as one example of a medium accommodation part such that the corresponding paper-feeding trays TR1, TR2, TR3, and TR4 are insertable and extractable in the front-rear direction. The paper-feeding trays TR1 to TR4 accommodate recording paper S as one example of a medium.

A pickup roller Rp as one example of a picking-out part is disposed at the left and above the paper-feeding trays TR1 to TR4. A separating roller Rs as one example of a separating part is disposed downstream of the pickup roller Rp in a transport direction of the recording paper S. As one example of a medium transport path, a paper-feeding path SH1 extending upward is formed downstream of the separating roller Rs in the transport direction of the recording paper S. Multiple transport rollers Ra as one example of a transport part is disposed along the paper-feeding path SH1.

At a left lower portion of the copier U, a manual feeding tray TR0 as one example of a medium accommodation part is disposed. At a right upper portion of the manual feeding tray TR0, a pickup roller Rp0 is disposed with a manual paper-feeding path SH0 extending. The manual paper-feeding path SH0 joins the paper-feeding path SH1.

At the paper-feeding path SH1, a registration roller Rr as one example of a transport-timing adjustment part is disposed upstream of the second transfer region Q4. A transport path SH2 extends from the registration roller Rr toward the second transfer region Q4.

A fixation device F as one example of a fixation part is disposed downstream of the second transfer region Q4 in the transport direction of the recording paper S. The fixation device F includes a heating roller Fh as one example of a fixation member for heating and a pressurization roller Fp as one example of a fixation member for pressurization. A region where the heating roller Fh and the pressurization roller Fp are in contact with each other constitutes a fixation region Q5.

A lower-tier paper output tray TRh as one example of a medium output portion is formed on the upper surface of the printer unit U1. In Example 1, a finisher U4 as one example of a post-processing device is set at the lower-tier paper output tray TRh. A paper output path SH3 as one example of a transport path extends above the fixation device F toward the lower-tier paper output tray TRh. A paper output roller Rh as one example of a medium transport part is disposed at a downstream end of the paper output path SH3.

An upper-tier paper output tray TRh2 as one example of a medium output portion is disposed above the lower-tier paper output tray TRh. An upward transport path SH4 branching from the paper output path SH3 and extending toward the upper-tier paper output tray TRh2 is formed above the fixation device F.

A bidirectionally rotatable reversing roller Rb as one example of a medium transport part is disposed at the upward transport path SH4. A reversing path SH6 as one example of a medium transport path branches, above a branch position of the paper output path SH3 and the upper transport path SH4, from the upward transport path SH4 to extend left-downward.

A gate GT1 as one example of a switching part is disposed to extend from a part where the paper output path SH3 and the upward transport path SH4 branch from each other to a part where the upward transport path SH4 and the reversing path SH6 branch from each other. The gate GT1 is supported to be switchable between a first guide position (second position) and a second guide position (first position), the first guide position being a position for guiding the recording paper S transported from the fixation device F toward the lower-tier paper output tray TRh and guiding the recording paper S from the upward transport path SH4 to the reversing path SH6, the second guide position being a position for guiding the recording paper S transported from the fixation device F to the upward transport path SH4.

Multiple transport rollers Ra as one example of a medium transport part are disposed along the reversing path SH6. The downstream end of the reversing path SH6 joins, upstream of the registration roller Rr, to the paper-feeding path SH1.

### Image Forming Operation

In the copier U in Example 1 with the aforementioned configuration, when an operator manually places the document Gi on the platen glass PG to copy the document Gi, the reading unit U2a moves in the left-right direction from an initial position and scans the document Gi on the platen glass PG while exposing the document Gi to light. When the automatic feeder U3 is used to automatically transport the document Gi to copy the document Gi, multiple documents Gi accommodated in the document tray TG1 are successively transported to and pass through a document reading position on the platen glass PG and is output onto the document paper output tray TG2. Each document Gi that passes through the reading position on the platen glass PG successively is scanned by being exposed to light by the reading unit U2a. Reflected light from the document Gi is received by the reading unit U2a. The reading unit U2a converts the received reflected light from the document Gi into an electric signal. When double-sided reading of the document Gi is to be performed, the document Gi is also read by a reading sensor.

The image processing unit GS receives electric signals output from the reading unit U2a. The image processing unit GS converts electric signals of images in R, G, and B colors read by the reading unit U2a into yellow (Y), magenta (M), cyan (C), and black (K) image information for latent image formation. The image processing unit GS outputs the image information after the conversion to the writing circuit DL of the printer unit U1. When an image is a single-color image, commonly known as a monochrome image, the image processing unit GS outputs only black (K) image information to the writing circuit DL.

The writing circuit DL outputs a control signal corresponding to the input image information to the exposure devices LHy to LHk. The exposure devices LHy to LHk output writing light corresponding to the control signal.

Each of the photoreceptors PRy to PRk is driven to rotate with a start of image formation. A charging voltage is applied to the charging rollers CRy to CRk from the power supply circuit E. Thus, the surfaces of the photoreceptors PRy to PRk are electrically charged by the charging rollers CRy to CRk. The exposure devices LHy to LHk each form, in the writing regions Q1y to Q1k, respectively, an electrostatic latent image onto a surface of a corresponding one of the charged photoreceptors PRy to PRk. The developing devices Gy to Gk develop the electrostatic latent images on the photoreceptors PRy to PRk corresponding thereto into toner images, as one example of visible images, in the development regions Q2y to Q2k, respectively.

The developed toner images are transported to the first transfer regions Q3y to Q3k corresponding thereto in contact with the intermediate transfer belt B as one example of an intermediate transfer body. A first transfer voltage with a polarity opposite to the charge polarity of toner is applied to the first transfer rollers T1y to T1k in the first transfer regions Q3y to Q3k, respectively, from the power supply circuit E. Thus, the toner images on the photoreceptors PRy to PRk are transferred onto the intermediate transfer belt B by the first transfer rollers T1y to T1k, respectively. For a multiple-color image, a toner image on the downstream side is transferred onto the intermediate transfer belt B so as to be superposed on a toner image that has been transferred in the first transfer region on the upstream side.

The photoreceptor cleaners CLy to CLk remove residues and adhering substances on the photoreceptors PRy to PRk after the first transfer, respectively. Static electricity on the surfaces of the photoreceptors PRy to PRk after the removal are eliminated by the static eliminators Jy to Jk, respectively. The surfaces of the photoreceptors PRy to PRk after the static elimination are electrically charged again by the charging rollers CRy to CRk, respectively.

A single-color toner image or multiple-color toner images transferred in the first transfer regions Q3y to Q3k onto the intermediate transfer belt B by the first transfer rollers T1y to T1k are transported to the second transfer region Q4.

The recording paper S on which an image is to be recorded is taken out by the pickup roller Rp from one of the paper-feeding trays TR1 to TR4 to be used. When multiple sheets of the recording paper S are taken out in a stacked state by the pickup roller Rp, the multiple sheets of the recording paper S are separated from each other by the separating roller Rs. The recording paper S separated by the separating roller Rs is transported through the paper-feeding path SH1 by the transport rollers Ra. The recording paper S that has been transported through the paper-feeding path SH1 is sent to the registration roller Rr. The recording paper S stacked on the manual feeding tray TR0 is also sent to the paper-feeding path SH1 through the manual paper-feeding path SH0 by the pickup roller Rp0.

The registration roller Rr transports the recording paper S to the second transfer region Q4 at the timing when a toner image formed on the intermediate transfer belt B is transported to the second transfer region Q4. A second transfer voltage with a polarity opposite to the charge polarity of toner is applied to the second transfer roller T2b by the power supply circuit E. Thus, the toner image on the intermediate transfer belt B is transferred from the intermediate transfer belt B onto the recording paper S.

The belt cleaner CLb removes an adhering substance and the like adhering to the surface of the intermediate transfer belt B after the second transfer. In addition, the second transfer roller T2b is cleaned by a second-transfer cleaner Clt as one example of a second-transfer cleaning device.

The recording paper S on which the toner image has been second-transferred is subjected to thermal fixation when passing through the fixation region Q5.

When post-processing is to be performed on the recording paper S on which the image has been fixed, the recording paper S is transported to the finisher U4 as one example of a post-processing device set at the lower-tier paper output tray TRh. When no post-processing is to be performed on the recording paper S, the recording paper S is transported to the upper-tier paper output tray TRh2. When the recording paper S is to be transported to the lower-tier paper output tray TRh, the gate GT1 moves to the first guide position. Thus, the recording paper S sent from the fixation device F is transported through the paper output path SH3. The recording paper S that has been transported through the paper output path SH3 is transported by the paper output roller Rh toward the finisher U4 and the lower-tier paper output tray TRh.

The finisher U4 outputs the recording paper S onto the lower-tier paper output tray TRh after performing fastening processing as one example of post-processing with respect to the recording paper S.

When the recording paper S is to be output onto the upper-tier paper output tray TRh2, the gate GT1 moves to the second guide position. The recording paper S is output onto the upper-tier paper output tray TRh2 through an upper-tier paper output port Rhb by a second paper output roller Rh2.

When double-sided printing of the recording paper S is to be performed, the gate GT1 moves to the second guide position. Then, when the rear end of the recording paper S passes through the gate GT1, the gate GT1 moves to the first guide position with the reversing roller Rb rotating reversely. Thus, the recording paper S is sent to the reversing path SH6 by being guided by the gate GT1. The recording paper S that has been transported through the reversing path SH6 is sent with the front and back sides thereof reversed to the registration roller Rr.

### Finisher U4

In FIG. 1, the finisher U4 in Example 1 includes a compile tray U4a as one example of a stack part. A staple device U4b as one example of a fastening device is disposed upstream of the compile tray U4a in a medium transport direction.

The lower-tier paper output tray TRh is disposed downstream of the compile tray U4a in the medium transport direction.

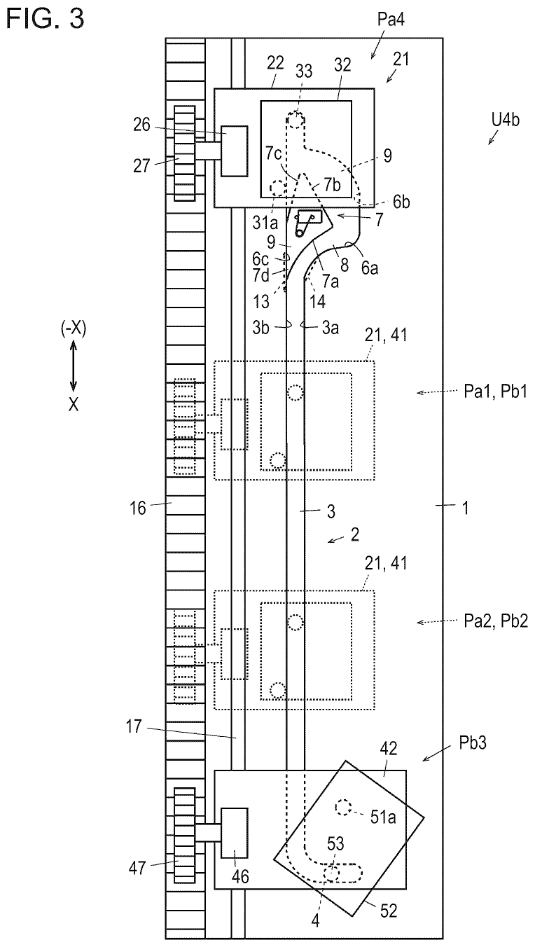

FIG. 3 is a plan view of the post-processing device in Example 1.

In FIG. 3, the staple device U4b in Example 1 includes a guide plate 1 as one example of a guide member. In Example 1, the guide plate 1 is disposed as a whole such that the left side thereof is lower in the direction of gravity than the right side thereof, which is the compile tray U4a side. That is, the guide plate 1 is inclined in a left downward direction. The compile tray U4a is not limited but may be inclined in the left downward direction with the guide plate 1 being also inclined in the left downward direction in order to align the edges of the recording paper S stacked on the compile tray U4a. The guide plate 1 may be disposed horizontally and also may be configured to be inclined in a right downward direction.

The guide plate 1 has a guide groove 2 as one example of a guiding part. The guide groove 2 in Example 1 includes, as one example of a first guide portion and as one example of an identical guide portion, an end-fastening guide portion 3 extending in the front-rear direction. A front corner fastening guide portion 4 as one example of a fifth guide portion is connected to the front end of the end-fastening guide portion 3. The front corner fastening guide portion 4 is inclined and curved rightward into an arc shape.

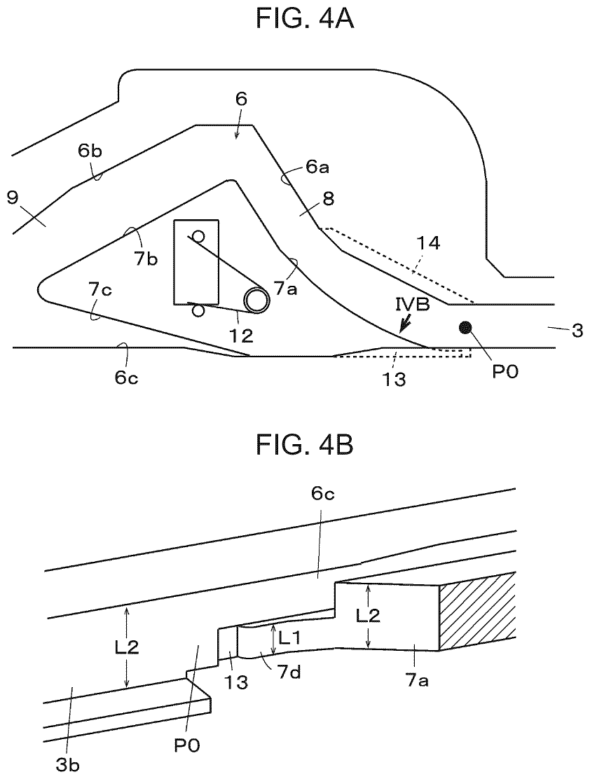

FIGS. 4A and 4B are explanatory views of portions of the guiding part and the switching part in Example 1. FIG. 4A is a plan view of a rear portion. FIG. 4B is a perspective view in the arrow IVB direction in FIG. 4A.

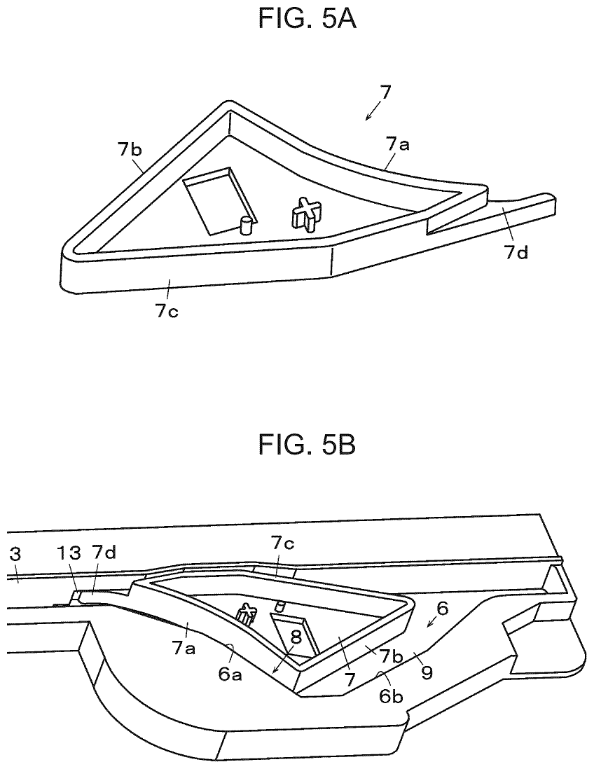

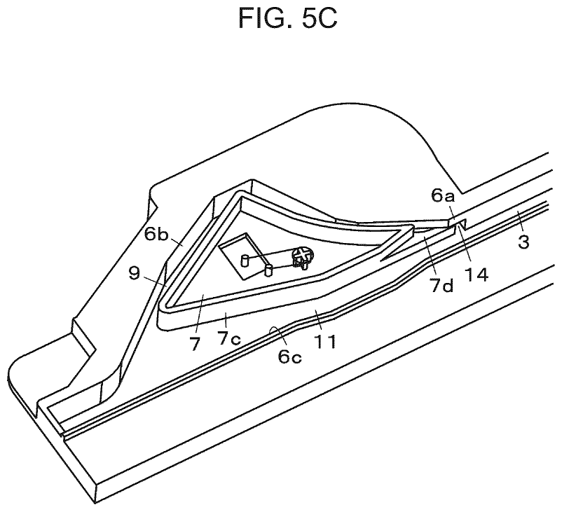

FIGS. 5A, 5B, and 5C are explanatory views of the switching part in Example 1. FIG. 5A is a perspective view of the switching part. FIG. 5B is an explanatory view of a state in which the switching part has moved to a second guide position. FIG. 5C is an explanatory view of a state in which the switching part has moved to a third guide position.

In FIGS. 4A and 4B and FIGS. 5A, 5B, and 5C, a protruding portion 6 protruding on the right side of an extension line of the end-fastening guide portion 3, that is, on the inner side of the compile tray U4a is formed at a rear end portion of the end-fastening guide portion 3. A first protruding right wall 6a connected to a right wall 3a of the end-fastening guide portion 3 and extending obliquely rearward to the right into an arc shape is formed at a right portion of the protruding portion 6. A second protruding right wall 6b extending obliquely rearward to the left is formed at the rear end of the first protruding right wall 6a. In addition, a protruding left wall 6c connected to a left wall 3b of the end-fastening guide portion 3 is formed at a left portion of the protruding portion 6. The protruding left wall 6c in Example 1 extends rearward straight on an extension of the left wall 3b of the end-fastening guide portion 3.

A switch gate 7 as one example of a switching part is disposed inside the protruding portion 6. The switch gate 7 in Example 1 includes a first gate wall 7a as one example of a first switch wall. The first gate wall 7a is disposed to face the first protruding right wall 6a. Thus, the first gate wall 7a extends obliquely rearward to the right from the front end into an arc shape. A second gate wall 7b as one example of a second switch wall is formed at a rear end portion of the first gate wall 7a. The second gate wall 7b is disposed to face the second protruding right wall 6b. Thus, the second gate wall 7b extends obliquely rearward to the left from the front end. The switch gate 7 also includes a third gate wall 7c as one example of a third switch wall. The third gate wall 7c is disposed to face the protruding left wall 6c. Thus, the third gate wall 7c extends rearward from the front end. The third gate wall 7c connects the front end of the first gate wall 7a and the rear end of the second gate wall 7b to each other. Thus, the switch gate 7 in Example 1 has a substantially triangular shape as a whole.

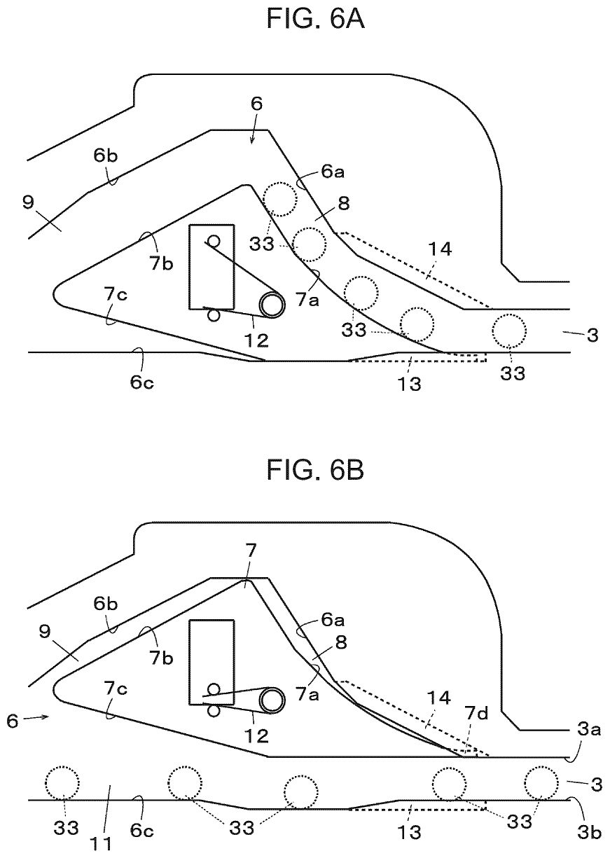

FIGS. 6A and 6B are explanatory views of the guiding part and the switching part in Example 1. FIG. 6A is an explanatory view of a state in which the switching part has moved to the second guide position. FIG. 6B is an explanatory view of a state in which the switching part has moved to the third guide position.

The switch gate 7 is supported to be movable straight in the left-right direction, that is, toward the inside or outside of the compile tray U4a. The switch gate 7 in Example 1 is supported to be movable between the second guide position (see FIG. 5B and FIG. 6A) at the left (toward the outside of the compile tray U4a) and the third guide position (see FIG. 5C and FIG. 6B) at the right (toward the inside of the compile tray U4a).

In FIG. 5B and FIG. 6A, a rear corner fastening guide portion 8 as one example of a second guide portion is formed between the first gate wall 7a of the switch gate 7 and the first protruding right wall 6a of the protruding portion 6 in the second guide position. In the second guide position, a retraction connection portion 9 as one example of a fourth guide portion is formed between the second gate wall 7b of the switch gate 7 and the second protruding right wall 6b of the protruding portion 6. That is, when the switch gate 7 has moved to the second guide position, the rear corner fastening guide portion 8 and the retraction connection portion 9 appear as the guide groove 2 between the switch gate 7 and the right wall 6a or 6b of the protruding portion 6.

In FIG. 5C and FIG. 6B, a retraction guide portion 11 as one example of a third guide portion is formed between the third gate wall 7c of the switch gate 7 and the protruding left wall 6c of the protruding portion 6 in the third guide position. That is, when the switch gate 7 has moved to the third guide position, the retraction guide portion 11 appears as the guide groove 2 between the switch gate 7 and the protruding left wall 6c.

The end-fastening guide portion 3, the front corner fastening guide portion 4, the rear corner fastening guide portion 8, the retraction connection portion 9, and the retraction guide portion 11 constitute the guide groove 2 in Example 1.

The switch gate 7 in Example 1 is urged toward the third guide position by a torsion spring 12 as one example of an urging part.

The switch gate 7 includes a branch portion 7d at a front end part. The branch portion 7d is disposed at a position (branch position P0) where the rear corner fastening guide portion 8 and the retraction guide portion 11 branch from each other.

Thus, the branch portion 7d in Example 1 is disposed at a position closer than each of the gate walls 7a and 7c to the branch position P0. In other words, each of the gate walls 7a and 7c as one example of a switch guide portion is disposed at a position further than the branch portion 7d from the branch position P0.

In FIG. 4B, the branch portion 7d in Example 1 has a length L1 in the height direction, and the length L1 is shorter than a length L2 of each of portions that differ from the branch portion 7d. The switch gate 7 in Example 1 has the shorter length L1 only at the branch portion 7d and has the longer length L2 at each of the other portions, which are the gate walls 7a to 7c. More specifically, in Example 1, the gate walls 7a to 7c and the right walls 6a and 6b and the left wall 6c of the protruding portion 6 have the same length L2, and only the branch portion 7d has the low length L1.

In FIG. 4B and FIG. 5B, the protruding left wall 6c has a first accommodation recess 13 as one example of an accommodation part. The first accommodation recess 13 has a height that enables the first accommodation recess 13 to accommodate the branch portion 7d. Therefore, the height of the first accommodation recess 13 is higher than the height of the branch portion 7d and lower than the height of the protruding left wall 6c. In other words, in the second guide position, the branch portion 7d is placed in a space on the left side (on the outer side of the compile tray U4a) with respect to the right surface of the protruding left wall 6c. In addition, the first accommodation recess 13 is longer than the branch portion 7d in the front-rear direction. Thus, in a state in which the switch gate 7 has moved to the second guide position, the branch portion 7d is accommodated in the first accommodation recess 13. It is thus possible, even when a manufacturing error, a wobble, or the like is present in the branch portion 7d, to reliably accommodate the branch portion 7d in the first accommodation recess 13 and to suppress a step, compared with when the first accommodation recess 13 has a length shorter than or equal to the length of the branch portion 7d. In Example 1, in a state in which the branch portion 7d is accommodated in the first accommodation recess 13, the right surface (the outer surface on the first protruding right wall 6a side) of the branch portion 7d and a surface (guide surface) of the protruding left wall 6c are flush with each other. That is, it is configured such that no step is formed between the right surface of the branch portion 7d and the surface of the protruding left wall 6c.

In FIG. 5C, the first protruding right wall 6a has a second accommodation recess 14 as one example of a second accommodation part. As with the first accommodation recess 13, the second accommodation recess 14 has a height that enables the second accommodation recess 14 to accommodate the branch portion 7d. Therefore, the height of the second accommodation recess 14 is higher than the height of the branch portion 7d and lower than the height of the first protruding right wall 6a. In addition, the second accommodation recess 14 is also longer than the branch portion 7d in the front-rear direction. Thus, in a state in which the switch gate 7 has moved to the third guide position, the branch portion 7d is accommodated in the second accommodation recess 14 (see FIG. 5C and FIG. 6B).

In Example 1, in a state in which the branch portion 7d is accommodated in the second accommodation recess 14, the left surface (the outer surface on the protruding left wall 6c side) of the branch portion 7d and a surface (guide surface) of the first protruding right wall 6a are flush with each other. That is, it is configured such that no step is formed between the left surface of the branch portion 7d and the surface of the first protruding right wall 6a.

In FIG. 3, a rack tooth 16 as one example of a drive part is disposed at a left end portion of the guide plate 1. The rack tooth 16 in Example 1 has a plate shape extending in the front-rear direction, that is, a medium width direction and has an upper surface on which gears are formed.

A guide shaft 17 as one example of a guiding part is supported between the rack tooth 16 and the guide groove 2. The guide shaft 17 has a rod shape extending in the medium width direction.

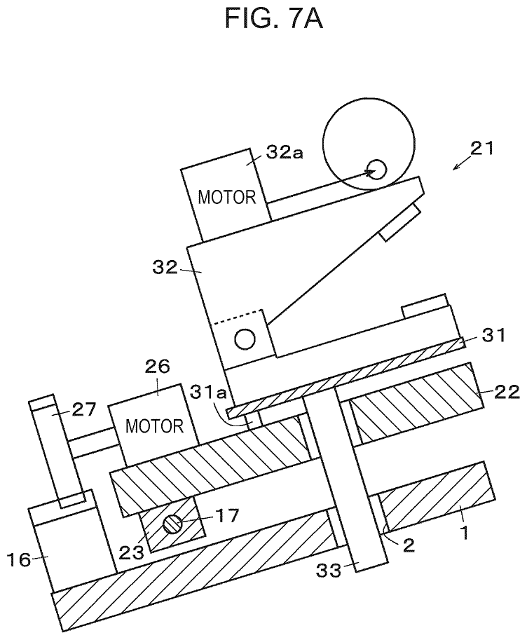

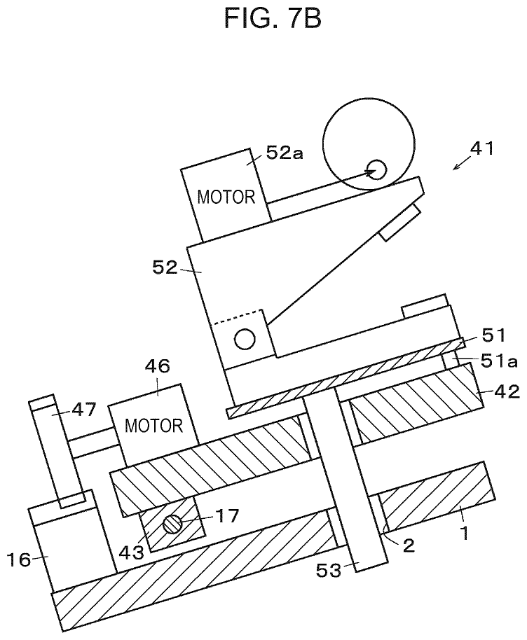

FIGS. 7A and 7B are explanatory views of a stapling unit in Example 1. FIG. 7A is an explanatory view of a stapleless stapling unit. FIG. 7B is an explanatory view of a staple stapling unit.

In FIG. 3, a stapleless stapling unit 21 as one example of a stapleless fastening device and as one example of a first unit is disposed at an upper portion of the guide plate 1.

In FIG. 3 and FIG. 7A, the stapleless stapling unit 21 includes a first carriage portion 22 as one example of a first moving part. The first carriage portion 22 is provided with a first guided portion 23 as one example of a first guided part. The guide shaft 17 extends through the first guided portion 23. Thus, the first guided portion 23 is movable along the guide shaft 17, and the first carriage portion 22 is movable along the guide shaft 17 in the front-rear direction, that is, in the medium width direction.

A first moving motor 26 as one example of a first driving source for movement is supported at a left portion of the first carriage portion 22. A first drive gear 27 as one example of a gear to which drive is transmitted from the first moving motor 26 meshes with the rack tooth 16. Thus, the first carriage portion 22 is able to move along the guide plate 1 in the front-rear direction and stop at a stapleless end-fastening position Pa1 or Pa2 or a stapleless corner fastening position Pa3 in response to the forward rotation, the reverse rotation, or the stoppage of the first moving motor 26.

The rack tooth 16, the guide shaft 17, the first guided portion 23, the first moving motor 26, and the like constitute a first moving mechanism 16 to 26 in Example 1.

A first rotary base 31 as one example of a first inclination part is disposed at an upper portion of the first carriage portion 22. The first rotary base 31 is supported to be rotatable about a first rotation shaft 31a with respect to the first carriage portion 22. A stapleless stapler 32 as one example of a first fastening part is supported at an upper portion of the first rotary base 31. The stapleless stapler 32 holds the recording paper S and fastens a bundle of the recording paper S without using a staple in response to an operation of a first operation motor 32a as one example of a first driving source for operation. As a method of fastening the recording paper S without using a staple, any publicly known method in the related art is employable. It may be possible to employ a method in which part of paper is torn or a method in which a pressure is applied in the thickness direction of paper so as to cause fibers to swine together or so as to deform paper.

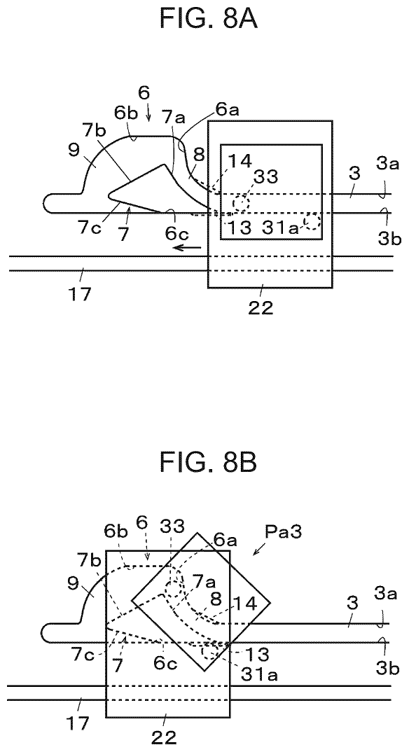

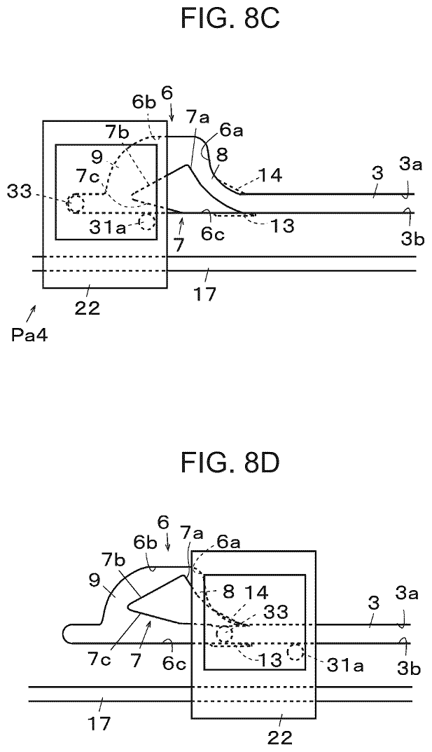

FIGS. 8A, 8B, 8C, and 8D are explanatory views of the movement of the stapleless stapling unit in Example 1. FIG. 8A is an explanatory view of a state in which the stapleless stapling unit has moved to an end fastening position. FIG. 8B is an explanatory view of a state in which the stapleless stapling unit has moved to a rear corner fastening position. FIG. 8C is an explanatory view of a state in which the stapleless stapling unit has moved to a retraction position. FIG. 8D is an explanatory view of a state while the stapleless stapling unit moves forward from the retraction position.

In FIG. 7A and FIGS. 8A, 8B, 8C, and 8D, a first inclined guide shaft 33 as one example of a first guided part is supported at a lower portion of the first rotary base 31. The first inclined guide shaft 33 extends through the first carriage portion 22 to be fitted to the guide groove 2.

In Example 1, the stapleless stapling unit 21 is inclined as a whole in the left downward direction in accordance with an inclination of the guide plate 1.

In FIG. 8A, in a state in which the first inclined guide shaft 33 is fitted to the end-fastening guide portion 3, the stapleless stapler 32 is in the state indicated by the broken lines in FIG. 3 and is capable of performing fastening at a fastening angle parallel to an edge of the recording paper S.

In FIG. 8B, when the first inclined guide shaft 33 advances into the rear corner fastening guide portion 8, the first inclined guide shaft 33 is guided along the rear corner fastening guide portion 8, and the first rotary base 31 and the stapleless stapler 32 rotate from the state illustrated in FIG. 8A into the state illustrated in FIG. 8B. Thus, it may be possible to perform fastening at a fastening angle inclined with respect to an edge of the recording paper S.

In FIG. 8C, when the first carriage portion 22 has moved rearward from the state in FIG. 8B, the first inclined guide shaft 33 reaches a stapleless-fastening retraction position Pa4 at the rear end by being guided by the retraction connection portion 9. Thus, as illustrated in FIG. 8C, the first rotary base 31 and the stapleless stapler 32 rotate from the state illustrated in FIG. 8B into the state illustrated in FIG. 8C. In Example 1, when fastening processing is ended, the stapleless stapling unit 21 retracts to and is on standby at the stapleless-fastening retraction position Pa4 illustrated in FIG. 8C.

In FIG. 8D, when the recording paper S is to be loaded into the compile tray U4a, the stapleless stapling unit 21 moves forward from the stapleless-fastening retraction position Pa4 in FIG. 8C. During this movement, the first inclined guide shaft 33 of the stapleless stapling unit 21 comes into contact with the rear end of the third gate wall 7c of the switch gate 7. Then, with the forward movement of the stapleless stapling unit 21, the first inclined guide shaft 33 pushes the switch gate 7 toward the third guide position, thereby moving the switch gate 7. Thus, the stapleless stapling unit 21 moves forward from the stapleless-fastening retraction position Pa4 against an elastic force of the torsion spring 12 while moving the switch gate 7 toward the third guide position.

When the stapleless stapling unit 21 has passed through the branch position P0, the switch gate 7 is moved (returned) to the second guide position by the elastic force of the torsion spring 12. Therefore, during a rearward movement of the stapleless stapling unit 21 from the stapleless end-fastening position Pa1 or Pa2, the first inclined guide shaft 33 is guided by the rear corner fastening guide portion 8 and the retraction connection portion 9.

In FIG. 3, a staple stapling unit 41 as one example of a staple fastening device and as one example of a second unit is disposed in front of the stapleless stapling unit 21.

In FIG. 3 and FIG. 7B, the staple stapling unit 41 in Example 1 includes a second carriage portion 42, a second guided portion 43, a second moving motor 46 as one example of a second driving source for movement, a second drive gear 47, a second rotary base 51, and a second inclined guide shaft 53, which are similar to the first carriage portion 22, the first guided portion 23, the first moving motor 26, the first drive gear 27, the first rotary base 31, and the first inclined guide shaft 33 of the stapleless stapling unit 21. Thus, in the staple stapling unit 41 in Example 1, the second carriage portion 42 is able to move along the guide plate 1 in the front-rear direction and stop at a staple end-fastening position Pb1 or Pb2 or a staple corner-fastening position Pb3 as one example of a staple fastening position in response to the forward rotation, the reverse rotation, or the stoppage of the second moving motor 46.

In Example 1, the staple end-fastening positions Pb1 and Pb2 are set at positions identical to the stapleless end-fastening positions Pa1 and Pa2, respectively. The staple end-fastening positions Pb1 and Pb2 and the stapleless end-fastening positions Pa1 and Pa2 are, however, not limited to be set at such identical positions and may be set at positions shifted from each other in a paper width direction.

As the second moving motor 46 in Example 1, a motor identical to a motor used as the first moving motor 26 is used. Thus, the motor capacity of the first moving motor 26 is identical to the motor capacity of the second moving motor 46. Therefore, identical components are used, and manufacturing costs may be reduced. While identical motors are used as the first moving motor 26 and the second moving motor 46 in Example 1, the first moving motor 26 and the second moving motor 46 are not limited thereto. In general, the first operation motor 32a of the stapleless stapler 32 has a larger capacity than an operation motor (second operation motor 52a) of the staple stapling unit 41. Therefore, the gross weight of the stapleless stapling unit 21 tends to be heavier than the gross weight of the staple stapling unit 41. In consideration of the above, a motor with a capacity larger than the capacity of the second moving motor 46 may be used as the first moving motor 26.

The staple stapling unit 41 in Example 1 includes, instead of the stapleless stapler 32 of the stapleless stapling unit 21, a staple stapler 52 as one example of a second fastening part. The staple stapler 52 fastens the recording paper S by driving a staple into the recording paper S in accordance with an operation of the second operation motor 52a as one example of a second driving source for operation. Thus, the staple stapling unit 41 in Example 1 may be able to execute post-processing different from post-processing executed by the stapleless stapling unit 21.

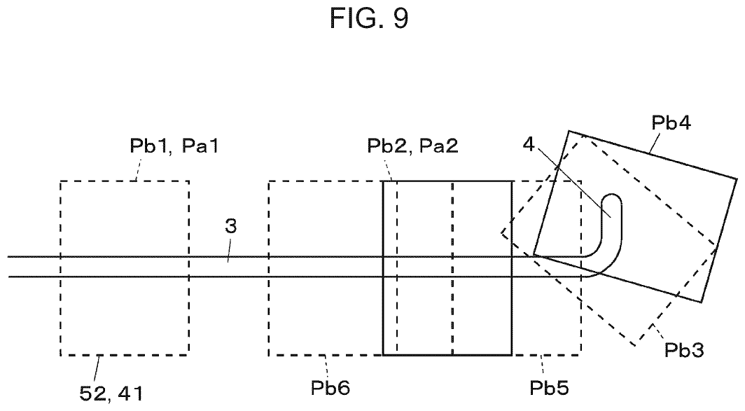

FIG. 9 is an explanatory view of the movement of the staple stapling unit in Example 1.

In FIG. 3, in a state in which the second inclined guide shaft 53 as one example of a guided part is fitted to the end-fastening guide portion 3, the staple stapler 52 is able to perform fastening at a fastening angle parallel to the edge of recording paper S as indicated by the broken lines of the positions of the staple end-fastening positions Pb1 and Pb2 in FIG. 3.

When the second inclined guide shaft 53 advances into the front corner fastening guide portion 4, the second inclined guide shaft 53 is guided along the front corner fastening guide portion 4, and the second rotary base 51 and the staple stapler 52 rotate from the state indicated by the broken lines in FIG. 3 into the state indicated by the solid lines in FIG. 3. Thus, it may be possible at the staple corner-fastening position Pb3 illustrated in FIG. 3 and FIG. 9 to perform fastening at a fastening angle inclined with respect to the edge of the recording paper S.

In FIG. 9, when fastening processing is ended, the staple stapling unit 41 in Example 1 retracts to and is on standby at a staple-fastening retraction position Pb4 in front of the staple corner-fastening position Pb3. Note that it may be possible to employ a form in which the staple corner-fastening position Pb3 is used as, that is, identical to the staple-fastening retraction position of the staple stapling unit 41.

In Example 1, the staple stapling unit 41 is refilled with staples at the staple-fastening retraction position Pb4. That is, at the staple-fastening retraction position Pb4, a front surface door (not illustrated) of the finisher U4 is opened, and staples are supplied. Thus, the staple-fastening retraction position Pb4 is used as, that is, identical to a staple supply position. The staple-fastening retraction position Pb4 and the staple supply position are set at an identical position in Example 1 but are not limited thereto. The staple-fastening retraction position Pb4 and the staple supply position may be set at different positions. Alternatively, the staple corner-fastening position Pb3 and the staple-fastening retraction position Pb4 may be set at an identical position while only the staple supply position is set at a different position. In addition, it is also possible to make any change, for example, setting the staple corner-fastening position Pb3 and the staple supply position at an identical position while setting only the staple-fastening retraction position Pb4 at a different position.

In Example 1, the stapleless stapling unit 21 and the staple stapling unit 41 use the identical guide groove 2 while the retraction positions of the stapleless stapling unit 21 and the staple stapling unit 41 are separated from each other on the far side and the opposite side on the front side. If the two retraction positions are set on the same side (for example, the rear side), there may be an issue of the size of the entirety of the apparatus being easily increased due to the need of ensuring a space to avoid overlapping of the two retraction positions or the need of lengthening also the guide groove connected to each of the retraction positions, as in the configuration described in Japanese Unexamined Patent Application Publication No. 2022-125834. In contrast, the size increase of the entirety of the apparatus may be suppressed in Example 1, compared with when the retraction positions are set on the same side.

### Controller in Example 1

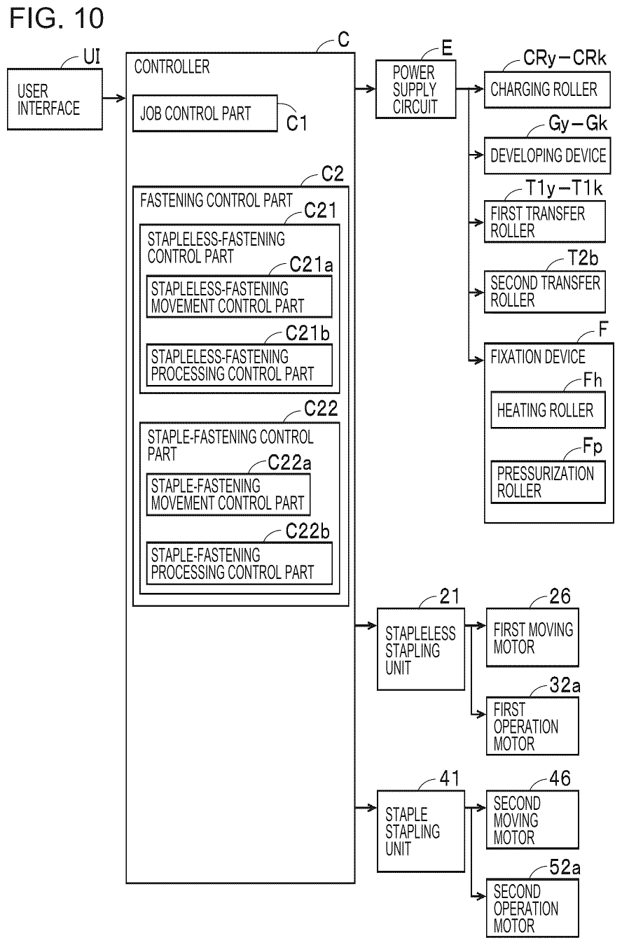

FIG. 10 is a functional block diagram of the controller in Example 1.

In FIG. 10, the controller C of the copier U includes an input-output interface I/O that performs, for example, outputting and receiving of signals to and from the outside. The controller C also includes read-only memory (ROM) in which a program, information, and the like for performing required processing are stored. The controller C also includes a random access memory (RAM) for temporarily storing required data. The controller C also includes a central processing unit (CPU) that performs processing corresponding to a program stored in the ROM or the like. Thus, the controller C in Example 1 is constituted by a small information processing device, commonly known as a microcomputer. Therefore, the controller C may realize various functions by executing a program stored in the ROM or the like.

The controller C in Example 1 receives a signal from a signal output element and controls a control target element by outputting a signal to the control target element.

### Signal Output Element

The controller C receives signals from signal output elements of a user interface UI and other sensors or the like (not illustrated).

The user interface UI inputs a content received from a user or an operator to the controller C.

### Control Target Element

The controller C outputs signals to the power supply circuit E, the first moving motor 26, the first operation motor 32a, the second moving motor 46, the second operation motor 52a, and other control target elements (not illustrated).

The power supply circuit E controls the charging bias of the charging rollers CRy to CRk, the developing bias of the developing devices Gy to Gk, the first transfer bias of the first transfer rollers T1y to T1k, the second transfer bias of the second transfer roller T2b, power supply to a heater of the fixation device F, and the like.

The first moving motor 26 moves the stapleless stapling unit 21 in the front-rear direction.

The first operation motor 32a actuates the stapleless stapler 32 to perform stapleless fastening.

The second moving motor 46 moves the staple stapling unit 41 in the front-rear direction.

The second operation motor 52a actuates the staple stapler 52 to perform staple fastening.

### Functions of Controller C

The controller C in Example 1 includes the following functional parts (functional module, program module).

A job control part C1 controls a job that is an image forming operation. When the job is started, photoconductor drums PRy to PRk, the power supply circuit E, and the like are controlled to form an image on the recording paper S.

A fastening control part C2 includes a stapleless-fastening control part C21 and a staple-fastening control part C22. The fastening control part C2 controls fastening processing by controlling the stapleless stapling unit 21 and the staple stapling unit 41.

The stapleless-fastening control part C21 includes a stapleless-fastening movement control part C21a and a stapleless-fastening processing control part C21b. The stapleless-fastening control part C21 controls the stapleless fastening processing by controlling the stapleless stapling unit 21.

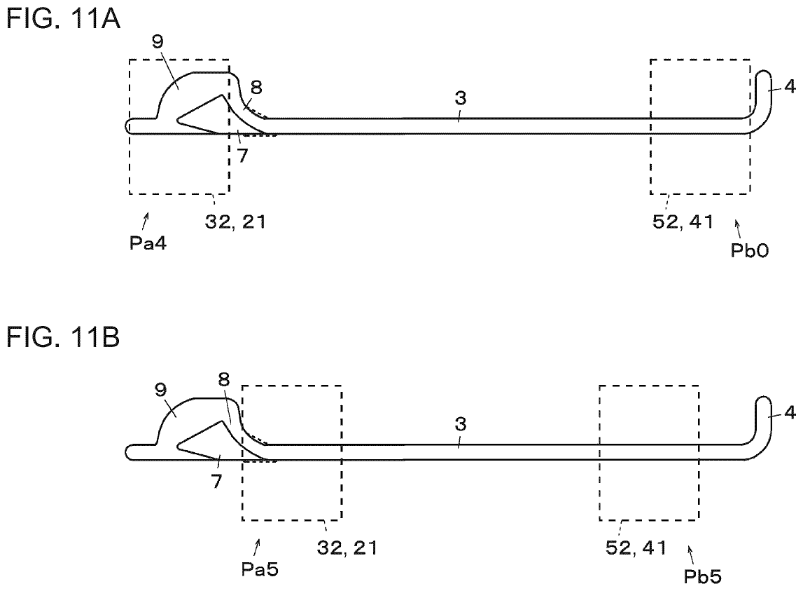

FIGS. 11A and 11B are explanatory views of positions of the fastening device in Example 1. FIG. 11A is an explanatory view of a position for a non-operation time. FIG. 11B is an explanatory view of a position for performing alignment processing.

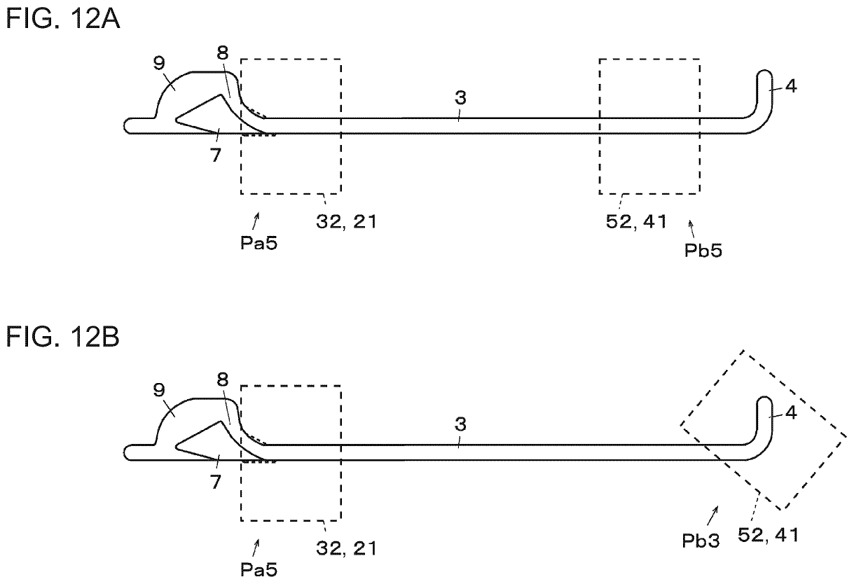

FIGS. 12A and 12B are explanatory views of positions at which the fastening device in Example 1 performs staple corner fastening. FIG. 12A is an explanatory view of a position for a paper loading time. FIG. 12B is an explanatory view of a state in which the fastening device has moved to the staple corner-fastening position.

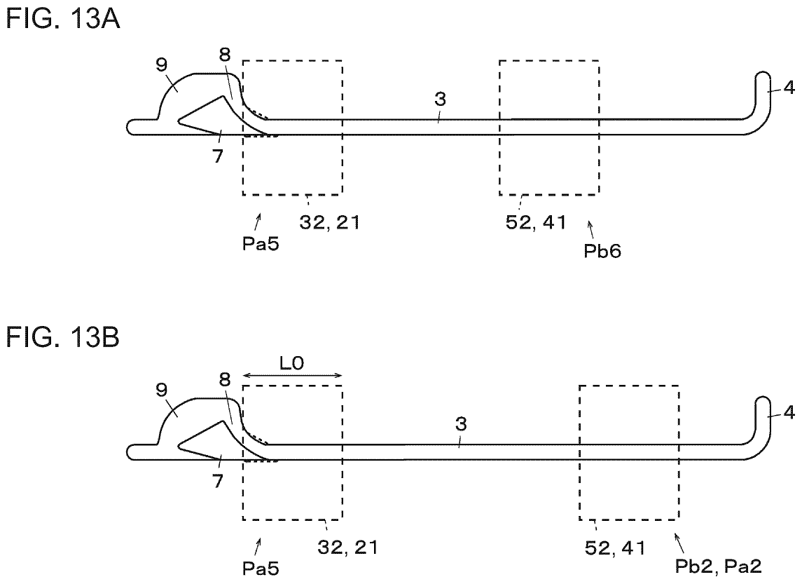

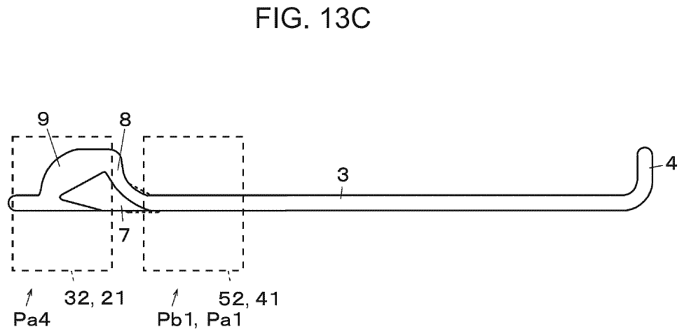

FIGS. 13A, 13B, and 13C are explanatory views of positions at which the fastening device in Example 1 performs staple end fastening. FIG. 13A is an explanatory view of a position for a paper loading time. FIG. 13B is an explanatory view of a state of first stapling of the staple end fastening. FIG. 13C is an explanatory view of a state of second stapling of the staple end fastening.

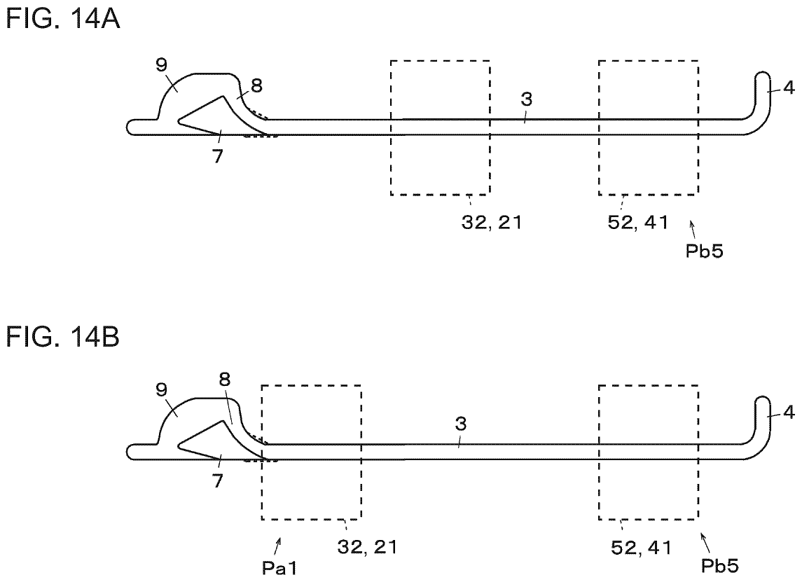

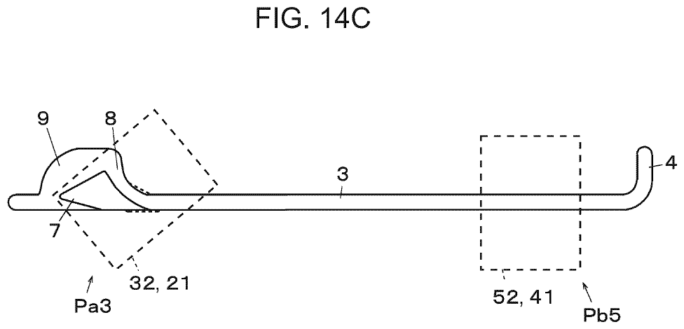

FIGS. 14A, 14B, and 14C are explanatory views of positions at which the fastening device in Example 1 performs stapleless corner fastening. FIG. 14A is an explanatory view of a state in which the fastening device has passed through the switching part before paper loading. FIG. 14B is an explanatory view of a position for a paper loading time. FIG. 14C is an explanatory view of a state in which the fastening device has moved to a stapleless corner-end fastening position.

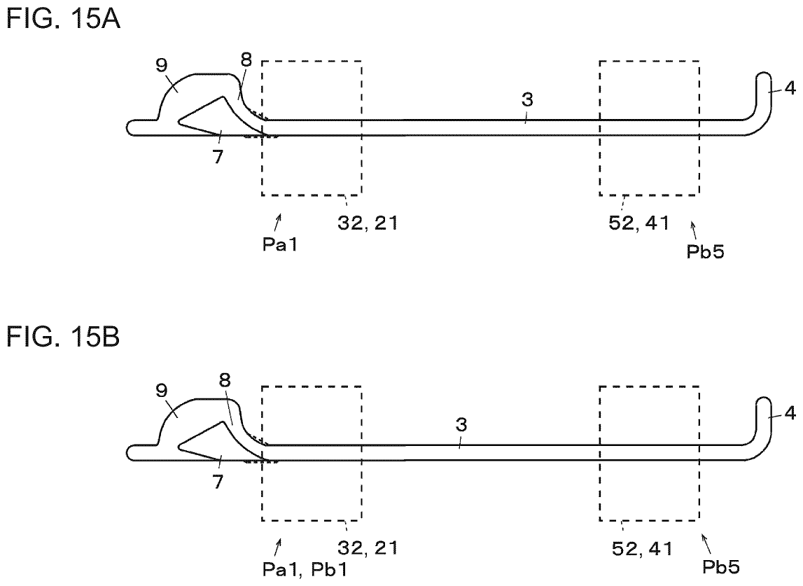

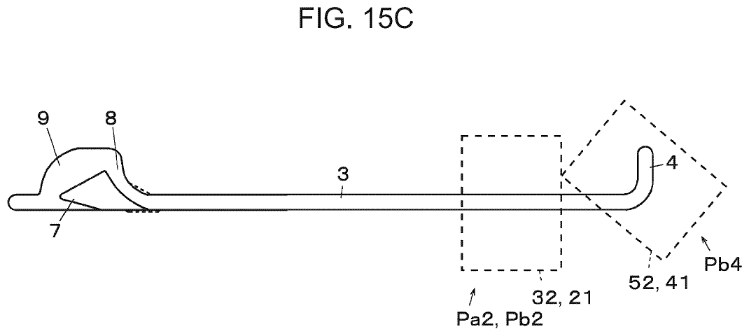

FIGS. 15A, 15B, and 15C are explanatory views of positions at which the fastening device in Example 1 performs stapleless end fastening. FIG. 15A is an explanatory view of a position for a paper loading time. FIG. 15B is an explanatory view of a state of first stapling of the stapleless end fastening. FIG. 15C is an explanatory view of a state of second stapling of the stapleless end fastening.

The stapleless-fastening movement control part C21a controls the movement of the stapleless stapling unit 21 via the first moving motor 26.

In FIG. 11A, the stapleless-fastening movement control part C21a in Example 1 moves the stapleless stapling unit 21 to the stapleless-fastening retraction position Pa4 when post-processing is not to be executed.

In FIG. 11B, when alignment processing (unstaple processing) in which the recording paper S is loaded into the compile tray U4a and in which a bundle of the recording paper S is however output in an aligned state without being fastened, the stapleless-fastening movement control part C21a in Example 1 moves the stapleless stapling unit 21 to a stapleless-fastening standby position Pa5. Therefore, the stapleless stapling unit 21 stops and is on standby at the stapleless-fastening standby position Pa5. In this state, during loading of the recording paper S into the compile tray U4a, the leading end portion of the recording paper S advances into a space in the stapleless stapler 32 on standby. Therefore, the leading end portion of the loaded recording paper S may be suppressed by the stapleless stapler 32 not to curl up and down. Thus, it may be possible to suppress curl of the recording paper S by also using the stapleless stapler 32, even when the length of an alignment member of the compile tray U4a, commonly known as an end wall, is short. When alignment processing is ended, the stapleless-fastening movement control part C21a moves the stapleless stapling unit 21 to the stapleless-fastening retraction position Pa4.

When staple corner fastening is to be performed, the stapleless-fastening movement control part C21a in Example 1 moves the stapleless stapling unit 21 to the stapleless-fastening standby position Pa5 as illustrated in FIG. 12A. Even when loading of the recording paper S is completed, the stapleless stapling unit 21 is kept at the stapleless-fastening standby position Pa5 as illustrated in FIG. 12B. Then, when the staple stapling unit 41 ends staple corner fastening, the stapleless stapling unit 21 is moved to the stapleless-fastening retraction position Pa4 as illustrated in FIG. 11A.

When staple end fastening is to be performed, the stapleless-fastening movement control part C21a in Example 1 moves the stapleless stapling unit 21 to the stapleless-fastening standby position Pa5 as illustrated in FIG. 13A. After loading of the recording paper S is completed, the stapleless stapling unit 21 is kept at the stapleless-fastening standby position Pa5 as illustrated in FIG. 13B until the staple stapling unit 41 completes first stapling of staple fastening processing. When the staple stapling unit 41 moves from the staple end-fastening position Pb2 for first stapling to the staple end-fastening position Pb1 for second stapling, the stapleless-fastening movement control part C21a moves the stapleless stapling unit 21 to the stapleless-fastening retraction position Pa4 as illustrated in FIG. 13C.

Here, the moving timing of the stapleless stapling unit 21 overlaps the timing of the movement of the staple stapling unit 41 from the staple end-fastening position Pb2 for first stapling to the staple end-fastening position Pb1 for second stapling. If the staple stapling unit 41 starts moving after the movement of the stapleless stapling unit 21 is completed, total time required for the movements becomes long. However, when the moving timings overlap each other, the movements may be completed in a short time. Therefore, a reduction in the total time required for the movement may be addressed.

At this time, the stapleless-fastening movement control part C21a in Example 1 controls the moving speed of the stapleless stapling unit 21 to be slower than the moving speed of the staple stapling unit 41. Specifically, the first moving motor 26 is controlled such that the moving speed of the stapleless stapling unit 21 becomes a low speed. Thus, the number of rotation of the first moving motor 26 is controlled to be less than the number of rotation of the second moving motor 46 having the same capacity.

When the units 21 and 41 are moved, vibration is generated. The higher the speed of the movements thereof, the more the vibration becomes large easily. In addition, when the moving timings of the two units 21 and 41 overlap each other, the vibration becomes large easily compared with when the moving timings do not overlap each other. In consideration of the above, although the moving timings of the two units 21 and 41 overlap each other, the moving speed of the stapleless stapling unit 21 having a heavy weight is set to be a low speed in Example 1. Therefore, compared with when the two units 21 and 41 are moved at the same speed, vibration of the finisher U4 may be suppressed.

The speed difference between the moving speeds of the units 21 and 41 is set to a speed difference that does not cause the staple stapling unit 41 moving at a high speed to bump into or collide with the stapleless stapling unit 21 moving at a low speed.

Here, in Example 1, a distance between the stapleless-fastening standby position Pa5 and the stapleless-fastening retraction position Pa4 is shorter than a distance Lb between the staple end-fastening position Pb2 at which the staple stapling unit 41 performs first stapling and the staple end-fastening position Pb1 at which the staple stapling unit 41 performs second stapling. Thus, it may be not easy for the staple stapling unit 41 that moves at a high speed to bump into the stapleless stapling unit 21 that moves at a low speed.

In Example 1, moving speeds Va and Vb are set such that a time ta (=L0/Va) and a time tb (=Lb/Vb) at least satisfy ta<tb, the time ta being a time required for the stapleless stapling unit 21 to move at the moving speed Va by a distance corresponding to a width L0 of the stapleless stapling unit 21 from the stapleless-fastening standby position Pa5 close to the staple end-fastening position Pb1 for second stapling, the time tb being a time required for the staple stapling unit 41 to move by the distance Lb between the staple end-fastening positions Pb1 and Pb2 at the moving speed Vb.

In Example 1, movement start timings of the stapleless stapling unit 21 and the staple stapling unit 41 are set to be identical, that is, the same timings. Setting the same timings may ease control.

A movement end timing of each of the units 21 and 41 is a timing when each of the units 21 and 41 reaches a target position. Here, the moving speeds Va and Vb may be set so as to intentionally cause the movement end timings to be identical to each other. Setting the movement end timings to be identical to each other simplifies control processing. Conversely, the moving speeds Va and Vb may be set so as to intentionally stagger the movement end timings. When the movement end timings are staggered, a period in which vibrations from the units 21 and 41 do not overlap each other or are not amplified may be increased.

In stapleless corner fastening, the stapleless-fastening movement control part C21a in Example 1 causes, as illustrated in FIG. 14A, the stapleless stapling unit 21 to once pass through the switch gate 7 and move to the front of the branch position P0. Then, the stapleless stapling unit 21 is moved rearward to the stapleless end-fastening position Pa1 illustrated in FIG. 14B. In Example 1, the stapleless end-fastening position Pa1 is used as a standby position of the stapleless stapling unit 21 during paper loading. In other words, the stapleless end-fastening position Pa1 is a position identical to a second stapleless-fastening standby position. The second stapleless-fastening standby position (stapleless end-fastening position Pa1) is located in front of the stapleless-fastening standby position Pa5. However, the second stapleless-fastening standby position is close to the stapleless-fastening standby position Pa5 and is a position almost the same as the stapleless-fastening standby position Pa5. The second stapleless-fastening standby position (stapleless end-fastening position Pa1) and the stapleless-fastening standby position Pa5 may be set at an identical position.

The recording paper S is loaded into the compile tray U4a in a state in which the stapleless stapling unit 21 has moved to the second stapleless-fastening standby position (stapleless end-fastening position Pa1).

When loading of the recording paper S is completed, the stapleless-fastening movement control part C21a moves the stapleless stapling unit 21 to the stapleless corner fastening position Pa3 illustrated in FIG. 14C. When stapleless corner-fastening processing is ended, the stapleless stapling unit 21 is moved to the stapleless-fastening retraction position Pa4.

When stapleless end fastening is to be performed, the stapleless-fastening movement control part C21a in Example 1 causes the stapleless stapling unit 21 to once pass through the branch position P0 as illustrated in FIG. 14A and then move to the stapleless end-fastening position Pa1 illustrated in FIG. 15A, that is, the second stapleless-fastening standby position. When loading of the recording paper S is completed, stapleless fastening processing for first stapling is performed at the stapleless end-fastening position Pa1 as illustrated in FIG. 15B. When the stapleless end-fastening processing for the first stapling is completed, the stapleless-fastening movement control part C21a moves the stapleless stapling unit 21 to the stapleless end-fastening position Pa2 for second stapling illustrated in FIG. 15C. When the stapleless end-fastening processing for the second stapling is completed, the stapleless stapling unit 21 is moved to the stapleless-fastening retraction position Pa4.

The moving timing of the staple stapling unit 41 overlaps the timing of the movement of the stapleless stapling unit 21 from the stapleless end-fastening position Pa1 for the first stapling to the stapleless end-fastening position Pa2 for the second stapling. If the movement of the stapleless stapling unit 21 is started after the movement of the staple stapling unit 41 is completed, the total time of the movements increases. However, the movements are completed in a short time when the moving timings overlap each other.

The moving speed of the stapleless stapling unit 21 to move from the stapleless end-fastening position Pa1 for the first stapling to the stapleless end-fastening position Pa2 for the second stapling is controlled to be slower than the moving speed of the staple stapling unit 41, as with that in FIGS. 13A, 13B, and 13C.

The movement start timings of the units 21 and 41 are set to be the same timings. Therefore, a possibility of the stapleless stapling unit 21 bumping into the leading staple stapling unit 41 may be reduced since the moving speed of the following stapleless stapling unit 21 is slower than the moving speed of the staple stapling unit 41. When the movement start timings are staggered, the movement start timings of the units 21 and 41 are set such that the stapleless stapling unit 21 does not bump into the leading staple stapling unit 41.

The stapleless-fastening processing control part C21b controls the first operation motor 32a to perform stapleless fastening by the stapleless stapler 32. When stapleless end-fastening processing is to be performed, the stapleless-fastening processing control part C21b performs fastening processing in a state in which the stapleless stapling unit 21 has moved to the stapleless end-fastening position Pa1 or Pa2 after loading of the recording paper S. When stapleless corner-fastening processing is to be performed, the stapleless-fastening-processing control part C21b performs fastening processing in a state in which the stapleless stapling unit 21 has moved to the stapleless corner fastening position Pa3.

The staple-fastening control part C22 includes a staple-fastening movement control part C22a and a staple-fastening processing control part C22b. The staple-fastening control part C22 controls staple fastening processing by controlling the staple stapling unit 41.

The staple-fastening movement control part C22a controls the movement of the staple stapling unit 41 via the second moving motor 46.

In FIG. 11A, when post-processing is not to be executed, the staple-fastening movement control part C22a in Example 1 causes the staple stapling unit 41 to move to and be on standby at the initial position Pb0.

In FIG. 11B, when alignment processing is to be executed, the staple-fastening movement control part C22a causes the staple stapling unit 41 to move to and be on standby at a staple-fastening standby position Pb5. Therefore, as with the stapleless stapling unit 21, the leading end portion of the loaded recording paper S may be suppressed not to curl up and down. In Example 1, the staple-fastening standby position Pb5 is located in front of the staple end-fastening position Pb2. However, the staple-fastening standby position Pb5 is close to the staple end-fastening position Pb2 and is a position almost the same as the staple end-fastening position Pb2. The staple end-fastening position Pb2 and the staple-fastening standby position Pb5 may be set at an identical position. When alignment processing is ended, the staple-fastening movement control part C22a moves the staple stapling unit 41 to the initial position Pb0.

When staple corner fastening is to be performed, the staple-fastening movement control part C22a moves the staple stapling unit 41 to the staple-fastening standby position Pb5 as illustrated in FIG. 12A. When loading of the recording paper S is completed, the staple stapling unit 41 is moved to the staple corner-fastening position Pb3 illustrated in FIG. 12B. Then, when the staple stapling unit 41 ends staple corner fastening, the staple stapling unit 41 is moved to the initial position Pb0 illustrated in FIG. 11A.

When staple end fastening is to be performed, the staple-fastening movement control part C22a moves the staple stapling unit 41 to the second staple-fastening standby position Pb6 as illustrated in FIG. 13A. The second staple-fastening standby position Pb6 is set at a position that differs from the staple-fastening standby position Pb5 but may be set at a position identical to the staple-fastening standby position Pb5. After loading of the recording paper S is completed, the staple-fastening movement control part C22a moves the staple stapling unit 41 to the staple end-fastening position Pb2 for first stapling illustrated in FIG. 13B. When the staple stapling unit 41 completes staple fastening processing for the first stapling, the staple stapling unit 41 is moved to the staple end-fastening position Pb1 illustrated in FIG. 13B.

At this time, as described above, the staple-fastening movement control part C22a moves the staple stapling unit 41 at the moving speed Vb such that the moving speed Va of the stapleless stapling unit 21 is slower than the moving speed Vb.

In addition, the staple-fastening movement control part C22a moves the staple stapling unit 41 such that the moving timing of the stapleless stapling unit 21 and the moving timing of the staple stapling unit 41 overlap each other.

When fastening processing at the staple end-fastening position Pb1 is ended, the staple stapling unit 41 is moved to the initial position Pb0 illustrated in FIG. 11A.

When stapleless corner fastening is to be performed, the staple-fastening movement control part C22a moves the staple stapling unit 41 to the staple-fastening standby position Pb5 illustrated in FIG. 14B.

In FIG. 14B and FIG. 14C, the staple-fastening movement control part C22a keeps the staple stapling unit 41 at the staple-fastening standby position Pb5 until, after completion of loading of the recording paper S, the stapleless stapling unit 21 completes stapleless corner-fastening processing. When stapleless corner-fastening processing is completed, the staple-fastening movement control part C22a moves the staple stapling unit 41 to the initial position Pb0 illustrated in FIG. 11A.

When stapleless end fastening is to be performed, the staple-fastening movement control part C22a moves the staple stapling unit 41 to the staple-fastening standby position Pb5 illustrated in FIG. 15A. When loading of the recording paper S is completed, the staple stapling unit 41 is kept, as illustrated in FIG. 15B, at the staple-fastening standby position Pb5 until stapleless fastening processing for first stapling is completed. When the stapleless end-fastening processing for the first stapling is completed, the staple-fastening movement control part C22a moves the staple stapling unit 41 to the staple-fastening retraction position Pb4 as illustrated in FIG. 15C.

The timing of the movement of the staple stapling unit 41 to the staple-fastening retraction position Pb4 overlaps the timing of the movement of the stapleless stapling unit 21 from the stapleless end-fastening position Pa1 for the first stapling to the stapleless end-fastening position Pa2 for the second stapling. If the movement of the stapleless stapling unit 21 is started after the movement of the staple stapling unit 41 is completed, the total time of the movements increases. However, the movements are completed in a short time when the moving timings overlap each other.

When the stapleless stapling unit 21 moves between the stapleless end-fastening positions Pa1 and Pa2, the staple-fastening movement control part C22a moves the staple stapling unit 41 at the moving speed Vb such that the moving speed Va of the stapleless stapling unit 21 is slower than the moving speed Vb, as described above.

In addition, the staple-fastening movement control part C22a moves the staple stapling unit 41 such that the moving timing of the stapleless stapling unit 21 and the moving timing of the staple stapling unit 41 overlap each other.

When fastening processing at the stapleless end-fastening position Pa2 for the second stapling is ended, the staple stapling unit 41 is moved to the initial position Pb0 illustrated in FIG. 11A.

The staple-fastening processing control part C22b controls the second operation motor 52a to perform staple fastening by the staple stapler 52. When staple end fastening processing is to be performed, the staple-fastening processing control part C22b performs fastening processing in a state in which the staple stapling unit 41 has moved to the staple end-fastening position Pb1 or Pb2 after loading of the recording paper S. When staple corner fastening processing is to be performed, the staple-fastening-processing control part C22b performs fastening processing in a state in which the staple stapling unit 41 has moved to the staple corner-fastening position Pb3.

### Modifications

An example of the present disclosure has been described above in detail. The present disclosure is, however, not limited to the example and can be variously changed within the scope of the gist of the present disclosure described in the claims. Modifications (H01) to (H06) of the present disclosure will be presented below.

(H01) In the example, the copier U is presented as one example of an image forming apparatus. The image forming apparatus is, however, not limited thereto and can be constituted by, for example, a printer, a facsimile machine, or a multifunction machine or the like having multiple or all of the functions of these devices. In addition, the present disclosure is not limited to an electrophotographic image forming apparatus and is applicable also to any image forming apparatus, such as an inkjet or thermal transfer image forming apparatus.

(H02) In the example, a configuration in which developers of four colors are used in the copier U is presented as an example. The present disclosure is, however, not limited thereto and is also applicable to, for example, a monochrome image forming apparatus or a multiple-color image forming apparatus for three or less colors or five or more colors.

(H03) In the example, as one example of the image carrying part, the intermediate transfer belt B in an endless belt shape is presented. The present disclosure is, however, not limited thereto. For example, the present disclosure is also applicable to a cylindrical intermediate transfer drum, a photoconductor drum, or a photoconductor belt. In addition, the present disclosure is also applicable to a configuration with no intermediate transfer body and in which an image is recorded onto the recording paper S directly from a photoconductor.

(H04) In the example, as a unit that performs post-processing, a configuration including the stapleless stapling unit 21 and the staple stapling unit 41 is presented as an example. The present disclosure is, however, not limited thereto. For example, the present disclosure is also applicable to a configuration in which only one stapling unit is disposed on the guide plate 1. In addition, the present disclosure is also applicable to a configuration including three or more stapling units. Further, not limited to a stapling unit, the present disclosure is also applicable to a punching unit that forms a punched hole, a unit that forms a folded line, a unit that forms a perforation line, or the like.

(H05) In the example, a configuration in which the finisher U4 is installed at the lower-tier paper output tray TRh is presented as an example. The present disclosure is, however, not limited thereto. A post-processing device may be externally attached to a side portion of the copier U.

(H06) In the example, a configuration in which the rotary base 31, 51 moves with respect to the carriage portion 22, 42 by rotating is presented as an example. The present disclosure is, however, not limited thereto. For example, the present disclosure is applicable to a configuration in which the rotary base 31, 51 moves with respect to the carriage portion 22, 42 by sliding or to any forms, such as a form in which the rotary base 31, 51 moves by a combination of rotating and sliding.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A post-processing device comprising:
a staple fastening device that fastens a medium with a staple;
a stapleless fastening device that fastens a medium without using the staple; and
a guiding part that guides the staple fastening device and the stapleless fastening device such that the staple fastening device and the stapleless fastening device are movable in a width direction of a medium,
wherein a moving speed of the stapleless fastening device is slower than a moving speed of the staple fastening device when a moving timing of the staple fastening device and a moving timing of the stapleless fastening device overlap each other.
   (((2)))

The post-processing device according to (((1))),
wherein the staple fastening device is movable among a plurality of staple fastening positions at which the staple fastening device fastens a plurality of portions of an end of each medium and a staple-fastening retraction position to which the staple fastening device retracts away from the stapleless fastening device,
wherein the stapleless fastening device is movable among a plurality of stapleless fastening positions at which the stapleless fastening device fastens a plurality of portions of an end of each medium and a stapleless-fastening retraction position to which the stapleless fastening device retracts away from the staple fastening device,
wherein the staple-fastening retraction position is located at one end side of the medium in a width direction of the medium, and
wherein the stapleless-fastening retraction position is located at another end side of the medium in the width direction.
   (((3)))

The post-processing device according to (((1))) or (((2))),
wherein the staple fastening device is movable among a plurality of staple fastening positions at which the staple fastening device fastens a plurality of portions of an end of each medium and a staple-fastening retraction position to which the staple fastening device retracts away from the stapleless fastening device,
wherein the stapleless fastening device is movable among a plurality of stapleless fastening positions at which the stapleless fastening device fastens a plurality of portions of an end of each medium and a stapleless-fastening retraction position to which the stapleless fastening device retracts away from the staple fastening device, and
wherein, in fastening of a plurality of portions of an end of the medium with staples, the staple fastening device is moved along the guiding part while the stapleless fastening device is moved to the stapleless-fastening retraction position at a timing that overlaps a moving timing of the staple fastening device.
   (((4)))

The post-processing device according to (((3))),
wherein the stapleless fastening device is movable among the stapleless fastening positions, a stapleless-fastening standby position at which the stapleless fastening device is on standby, and the stapleless-fastening retraction position, and
wherein a distance between the stapleless-fastening standby position and the stapleless-fastening retraction position is shorter than a distance between a first staple fastening position at which the staple fastening device performs first stapling with a staple and a second staple fastening position at which the staple fastening device performs second stapling with a staple.
   (((5)))

The post-processing device according to any one of (((1))) to (((4))),
wherein the staple fastening device is movable among a plurality of staple fastening positions at which the staple fastening device fastens a plurality of portions of an end of each medium and a staple-fastening retraction position to which the staple fastening device retracts away from the stapleless fastening device,
wherein the stapleless fastening device is movable among a plurality of stapleless fastening positions at which the stapleless fastening device fastens a plurality of portions of an end of each medium and a stapleless-fastening retraction position to which the stapleless fastening device retracts away from the staple fastening device, and
wherein, in fastening of a plurality of portions of an end of the medium without using a staple, the stapleless fastening device is moved along the guiding part while the staple fastening device is moved to the staple-fastening retraction position at a timing that overlaps a moving timing of the stapleless fastening device.
   (((6)))

The post-processing device according to any one of (((1))) to (((5))), comprising:
a first driving source that moves the stapleless fastening device;
a second driving source that moves the staple fastening device, the second driving source having a motor capacity identical to a motor capacity of the first driving source; and
a control part that controls the first driving source and the second driving source such that a moving speed of the stapleless fastening device moved by the first driving source becomes slower than a moving speed of the staple fastening device moved by the second driving source.
   (((7)))

The post-processing device according to any one of (((1))) to (((6))),
wherein a movement start timing of the staple fastening device and a movement start timing of the stapleless fastening device are staggered.
   (((8)))

The post-processing device according to any one of (((1))) to (((7))),
wherein a movement end timing of the staple fastening device and a movement end timing of the stapleless fastening device are staggered.
   (((9)))

The post-processing device according to any one of (((1))) to (((6))),
wherein a movement start timing of the staple fastening device and a movement start timing of the stapleless fastening device coincide with each other.
   (((10)))

An image forming apparatus comprising:
an image recording device that records an image onto a medium; and
the post-processing device according to any one of (((1))) to (((9))), the post-processing device being configured to perform post-processing with respect to a medium on which an image has been recorded by the image recording device.

What is claimed is:

1. A post-processing device comprising:
a staple fastening device that fastens a medium with a staple;
a stapleless fastening device that fastens a medium without using the staple; and
a guiding part that guides the staple fastening device and the stapleless fastening device such that the staple fastening device and the stapleless fastening device are movable in a width direction of a medium,
wherein a moving speed of the stapleless fastening device is slower than a moving speed of the staple fastening device when a moving timing of the staple fastening device and a moving timing of the stapleless fastening device overlap each other.

2. The post-processing device according to claim 1,
wherein the staple fastening device is movable among a plurality of staple fastening positions at which the staple fastening device fastens a plurality of portions of an end of each medium and a staple-fastening retraction position to which the staple fastening device retracts away from the stapleless fastening device,
wherein the stapleless fastening device is movable among a plurality of stapleless fastening positions at which the stapleless fastening device fastens a plurality of portions of an end of each medium and a stapleless-fastening retraction position to which the stapleless fastening device retracts away from the staple fastening device,
wherein the staple-fastening retraction position is located at one end side of the medium in a width direction of the medium, and
wherein the stapleless-fastening retraction position is located at another end side of the medium in the width direction.

3. The post-processing device according to claim 1,
wherein the staple fastening device is movable among a plurality of staple fastening positions at which the staple fastening device fastens a plurality of portions of an end of each medium and a staple-fastening retraction position to which the staple fastening device retracts away from the stapleless fastening device,
wherein the stapleless fastening device is movable among a plurality of stapleless fastening positions at which the stapleless fastening device fastens a plurality of portions of an end of each medium and a stapleless-fastening retraction position to which the stapleless fastening device retracts away from the staple fastening device, and
wherein, in fastening of a plurality of portions of an end of the medium with staples, the staple fastening device is moved along the guiding part while the stapleless fastening device is moved to the stapleless-fastening retraction position at a timing that overlaps a moving timing of the staple fastening device.

4. The post-processing device according to claim 3,
wherein the stapleless fastening device is movable among the stapleless fastening positions, a stapleless-fastening standby position at which the stapleless fastening device is on standby, and the stapleless-fastening retraction position, and
wherein a distance between the stapleless-fastening standby position and the stapleless-fastening retraction position is shorter than a distance between a first staple fastening position at which the staple fastening device performs first stapling with a staple and a second staple fastening position at which the staple fastening device performs second stapling with a staple.

5. The post-processing device according to claim 1,
wherein the staple fastening device is movable among a plurality of staple fastening positions at which the staple fastening device fastens a plurality of portions of an end of each medium and a staple-fastening retraction position to which the staple fastening device retracts away from the stapleless fastening device,
wherein the stapleless fastening device is movable among a plurality of stapleless fastening positions at which the stapleless fastening device fastens a plurality of portions of an end of each medium and a stapleless-fastening retraction position to which the stapleless fastening device retracts away from the staple fastening device, and
wherein, in fastening of a plurality of portions of an end of the medium without using a staple, the stapleless fastening device is moved along the guiding part while the staple fastening device is moved to the staple-fastening retraction position at a timing that overlaps a moving timing of the stapleless fastening device.

6. The post-processing device according to claim 1, comprising:
a first driving source that moves the stapleless fastening device;
a second driving source that moves the staple fastening device, the second driving source having a motor capacity identical to a motor capacity of the first driving source; and
a control part that controls the first driving source and the second driving source such that a moving speed of the stapleless fastening device moved by the first driving source becomes slower than a moving speed of the staple fastening device moved by the second driving source.

7. The post-processing device according to claim 6,
wherein a movement start timing of the staple fastening device and a movement start timing of the stapleless fastening device are staggered.

8. The post-processing device according to claim 7,
wherein a movement end timing of the staple fastening device and a movement end timing of the stapleless fastening device are staggered.

9. The post-processing device according to claim 6,
wherein a movement start timing of the staple fastening device and a movement start timing of the stapleless fastening device coincide with each other.

10. An image forming apparatus comprising:
an image recording device that records an image onto a medium; and
the post-processing device according to claim 1, the post-processing device being configured to perform post-processing with respect to a medium on which an image has been recorded by the image recording device.

11. An image forming apparatus comprising:
an image recording device that records an image onto a medium; and
the post-processing device according to claim 2, the post-processing device being configured to perform post-processing with respect to a medium on which an image has been recorded by the image recording device.

12. An image forming apparatus comprising:
an image recording device that records an image onto a medium; and
the post-processing device according to claim 3, the post-processing device being configured to perform post-processing with respect to a medium on which an image has been recorded by the image recording device.

13. An image forming apparatus comprising:
an image recording device that records an image onto a medium; and
the post-processing device according to claim 4, the post-processing device being configured to perform post-processing with respect to a medium on which an image has been recorded by the image recording device.

14. An image forming apparatus comprising:
an image recording device that records an image onto a medium; and
the post-processing device according to claim 5, the post-processing device being configured to perform post-processing with respect to a medium on which an image has been recorded by the image recording device.

15. An image forming apparatus comprising:
an image recording device that records an image onto a medium; and
the post-processing device according to claim 6, the post-processing device being configured to perform post-processing with respect to a medium on which an image has been recorded by the image recording device.

16. An image forming apparatus comprising:
an image recording device that records an image onto a medium; and
the post-processing device according to claim 7, the post-processing device being configured to perform post-processing with respect to a medium on which an image has been recorded by the image recording device.

17. An image forming apparatus comprising:
an image recording device that records an image onto a medium; and
the post-processing device according to claim 8, the post-processing device being configured to perform post-processing with respect to a medium on which an image has been recorded by the image recording device.

18. An image forming apparatus comprising:
an image recording device that records an image onto a medium; and
the post-processing device according to claim 9, the post-processing device being configured to perform post-processing with respect to a medium on which an image has been recorded by the image recording device.

19. A post-processing device comprising:
a staple fastening device that fastens a medium with a staple;
a stapleless fastening device that fastens a medium without using the staple; and
guiding means for guiding the staple fastening device and the stapleless fastening device such that the staple fastening device and the stapleless fastening device are movable in a width direction of a medium,
wherein a moving speed of the stapleless fastening device is slower than a moving speed of the staple fastening device when a moving timing of the staple fastening device and a moving timing of the stapleless fastening device overlap each other.
